(19) United States
(12) Patent Application Publication
(10) Pub. No.: US 2018/0240304 A1
(43) Pub. Date: Aug. 23, 2018

(54) Rewards-Based Gaming System with In-game Ordering

(71) Applicant: Flo, LLC, New York, NY (US)

(72) Inventors: Eric J. BLATSTEIN, New York, NY (US); Manu GAMBHIR, Philadelphia, PA (US); Matt ROSEN, Media, PA (US)

(21) Appl. No.: 15/958,535

(22) Filed: Apr. 20, 2018

Related U.S. Application Data
(63) Continuation-in-part of application No. 15/934,432, filed on Mar. 23, 2018.
Application No. 15/934,432 is a continuation-in-part of application No. 15/202,219, filed on Jul. 5, 2016.
(60) Provisional application No. 62/255,605, filed on Nov. 16, 2015.

(51) Int. Cl. G07F 17/32; G06Q 30/06; G06Q 30/02; G06Q 50/12

(52) U.S. Cl. CPC G07F 17/3255; G06Q 50/12; G06Q 30/0238; G06Q 30/0641

(57) ABSTRACT

A rewards-based gaming system includes, in some embodiments, a gaming server, a rewards server, and a database server and integrates with the existing food or merchandise sales system of a business establishment. Patrons of the business have the opportunity to play a game, on an appropriately configured computing device, from a selection of games. Playing a game provides the player-patron with a chance to win rewards points, which can be electronically redeemed for prizes, using the same computing device. Game credits for playing games that are not free can be purchased for cash, cryptocurrency, or obtained in exchange for rewards miles or third-party loyalty points. The system also provides customers the ability to remotely order food and drink (e.g., using periodic reminders) delivered to the customer at an identified location, while playing a game on an electronic device that is fixed at a location or a handheld device.

### STATEMENT OF RELATED CASES

The present application is a continuation-in-part, claiming the benefit of the following pending U.S. patent applications: Ser. No. 15/934,432 filed on Mar. 23, 2018 and Ser. No. 15/202,219 filed on Jul. 5, 2016. Both of these applications are incorporated by reference herein.

### FIELD OF THE INVENTION

The present invention relates to incentive rewards systems and gaming systems.

### BACKGROUND OF THE INVENTION

Before smart phones and the iPad®, restaurant patrons occupied themselves while waiting for their meal by completing mazes and brain teasers on “game placemats” or by playing simple table games, such as “hang man,” “tic-tac-toe,” or “football.” Of late, parents keep their children occupied at the restaurant table with electronic games, such as can be played on tablet computers.

Although game placemats and electronic games help to pass the time, they do nothing to build a business establishment's brand or promote patronage thereof.

### SUMMARY OF THE INVENTION

The present invention provides a rewards-based gaming system for use in conjunction with a variety of businesses, such as restaurants, hotels, casinos, merchandise-sales establishments, etc. The system promotes patronage of such businesses by providing customers with a fun, engaging experience where they can win or earn items typically offered for sale at such establishments.

In accordance with the illustrative embodiment, the rewards-based gaming system integrates with the existing food or merchandise sales system of the business establishment. Integration requires relatively minor changes to the venue's existing sales system. Patrons of the business have the opportunity to play a game, on an appropriately configured computing device such as a tablet computer (e.g., Apple iPad®, Samsung Galaxy Tab models, etc.), from a selection of games. Playing a game provides the player-patron with a chance to win digital loyalty currency, referred to herein as “rewards points.” The rewards points can be electronically redeemed for prizes via the same computing device.

If a prize is in the form of food, drink, or merchandise, it can delivered to the player-patron with minimal delay (c.a., 15 to 30 minutes) based on the location of the computing device in the business establishment. If the prize is a discount or coupon that is to be applied to a regular purchase through the business' sales system, it can be delivered to the player-patron's computing device virtually instantaneously via an email, SMS, etc.

In the illustrative embodiment, the rewards-based gaming system includes a gaming server, a rewards server, and a database server.

In some embodiments, the gaming server is a client-server system that runs all of the games that are made available for play. Games fall under any one of the following four legal categories of gaming:
Sweepstakes: games must be free to play, can be games of chance, and prizes having real cash value can be won.
Gambling: games require consideration to play, can be games of chance, and prizes having real cash value can be won.
Loyalty: games require consideration to play, can be games of chance, prizes having real cash value cannot be won. Prizes are earned based on volume of play.
Skill: Games require consideration to play, cannot be games of chance, and prizes having real cash value can be won.

The gaming server manages three types of currencies: tokens, game credits, and reward points. Tokens are used to play games that are free, regardless of the type of game. Game credits are the currency used to play games that are not free. Rewards points are the currency that is redeemed for prizes. Additionally, rewards miles, such as from the mileage program of an airline, etc., and third-party loyalty points (e.g., points earned for patronizing any number of retailers, restaurants, etc.) can be used to purchase game credits.

The rewards server performs tasks related to prizes, such as, among other tasks, maintaining an updated list of the prize inventory, the pricing of prizes, handling the prize claim process, and interfacing with the business establishment's sales system.

The database server is a repository of information required by the gaming and rewards server to run the gaming system. The database server provides the gaming and rewards servers with an ability to query and retrieve information stored in its databases. Such information, much of which is updated (such as by the gaming and rewards servers) includes, without limitation, player-patron account information, token, game credit, and rewards points balances, prize and claim information, game play history, and computing device information.

The rewards-based gaming system provides several different revenue generation models, depending, for example and among any other considerations, on which legal category of gaming is used. Some examples of revenue generation models include:
Advertising. Player-patrons can earn game credits or tokens by watching paid advertisements or games can be directly sponsored by advertisers.
Sales of Game Credits. In skill, gambling, and loyalty-based games, game credits can be sold directly.
Increased Sales of Food/Merchandise. Tokens, game credits and/or rewards points can be given to player-patrons along with purchases of food or merchandise in order to drive more sales of same.

In an alternative embodiment, the rewards-based gaming system includes a gaming server, a rewards server, a database server, and one or more computing devices (e.g., tablet computers, etc.) running specialized gaming application software for playing games run by the gaming server.

In some embodiments, the owner/operator of the rewards-based gaming system is a third party that has no ownership or management interest in the business with which the gaming system is being used (e.g., restaurant, casino, etc.). In some other embodiments, the operator/owner of the rewards-based gaming system owns or operates the business with which the gaming system is being used. In yet some additional embodiments, the rewards-based gaming system is licensed to the business for use thereby.

### BRIEF DESCRIPTION OF THE DRAWINGS

FIG. 1A depicts rewards-based gaming system 100 in accordance with a first illustrative embodiment of the present invention being used by a patron of a business establishment.

FIG. 1B depicts rewards-based gaming system 100 in accordance with a second illustrative embodiment of the present invention being used by a patron of a business establishment.

FIG. 1C depicts rewards-based gaming system 100 in accordance with a third illustrative embodiment of the present invention being used by a patron of a business establishment.

FIG. 2 depicts a block diagram of the rewards-based gaming system 100 of FIGS. 1A through 1C.

FIG. 3 depicts a block diagram of an embodiment of a gaming server of the rewards-based gaming system.

FIG. 4 depicts a block diagram of an embodiment of a rewards server of the rewards-based gaming system.

FIG. 5 depicts a block diagram of an embodiment of a database server of the rewards-based gaming system.

FIG. 6 depicts a block diagram of a computing device for use in conjunction with the rewards-based gaming system.

FIG. 7 depicts contents of an information storage device of the gaming server of FIG. 3.

FIG. 8 depicts contents of an information storage device of the rewards server of FIG. 4.

FIG. 9 depicts contents of an information storage device of the database server of FIG. 5.

FIG. 10 depicts contents of an information storage device of the computing device of FIG. 6.

FIG. 11 depicts tasks performed by the rewards-based gaming system implementing a method in accordance with the present invention.

FIG. 12 depicts an illustrative screen shot of the computing device during game play.

FIG. 13 depicts an exemplary flowchart for implementation of periodic offering of food/beverage services to a user during a reward-based game, according to an embodiment of the invention.

FIG. 14 depicts an exemplary illustration of a reward-based game system that is configured to provide food/beverage services to a user during a game, according to an embodiment of the invention.

FIG. 15 depicts an exemplary simplified block diagram of a computing device being in communication with a business game establishment (BGE) through a communication network for providing food/beverage services to a user during a game, according to an embodiment of the invention.

### DETAILED DESCRIPTION

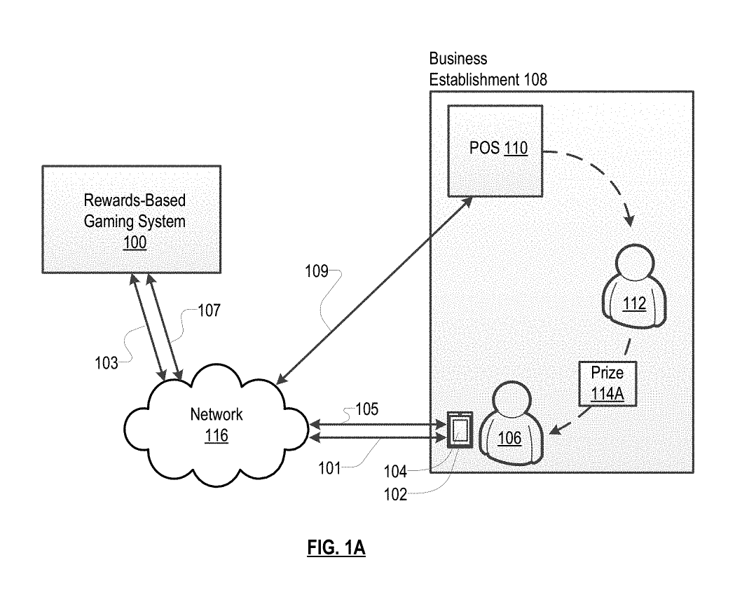

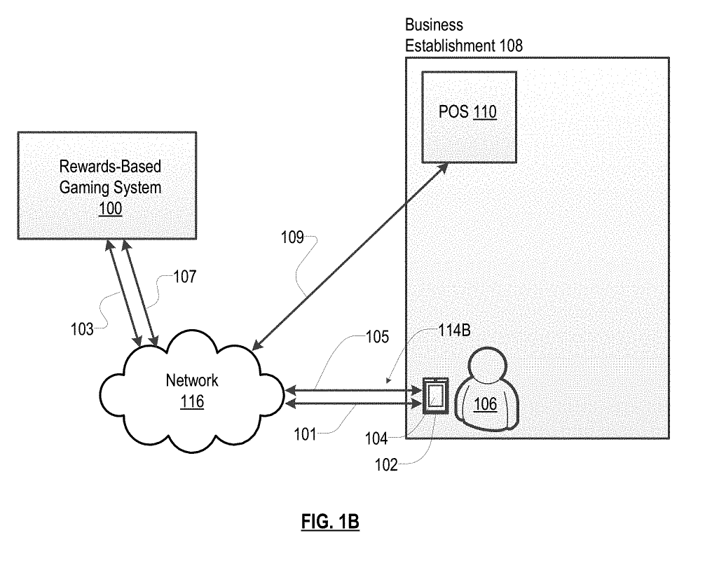

FIG. 1A depicts player-patron 106 in business establishment 108 using computing device 102 to play games available through rewards-based gaming system 100. Business establishment 108 includes point-of-sale system (“POS”) 110 and local service representative(s) 112. Gaming system 100, computing device 102, and POS 110 communicate with one another via wide area network 116, such as the Internet, among any other modes of communication.

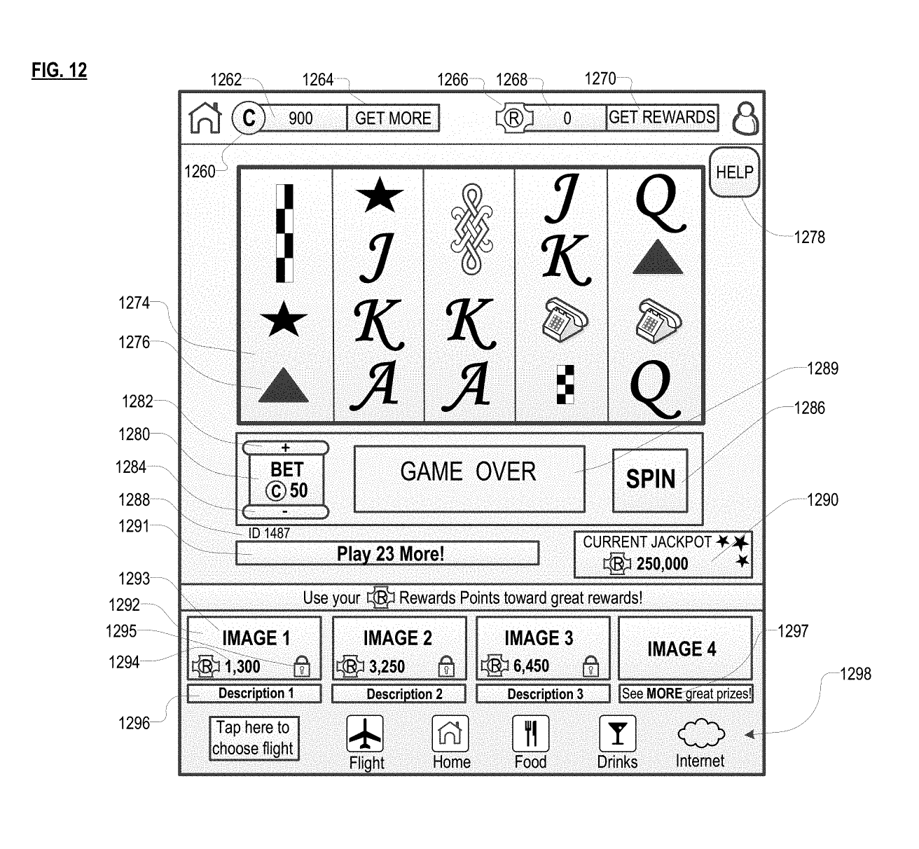

To play a game, player-patron 106 accesses a software application (“app”) on computing device 102 (e.g., tablet computer, smart phone, etc.). The application generates graphical user interface (“GUI”) 104 and causes it to be displayed in the display screen of computing device 102. GUI 104, unique for each game, presents to player-patron 106 the game's environment (e.g., for a slot machine: a representation of the reels, the symbols on the reels, etc.). The GUI is also the means by which player-patron 106 interacts with the game, such as via soft keys, to wager or make other game-related commands, etc. The GUI also displays the results of the player-patron's actions as well as status information, such as the amount of rewards points won/earned and the amount of available tokens or game credits. Additionally, GUI 104 presents prize options. An illustrative GUI 104 is described in further detail later in this specification in conjunction with FIG. 12.

Gaming system 100 handles the game logic; game play on computing device 102 requires bi-directional interactions with gaming system 100. The “gaming” interactions, supported for example by network 116, are represented by (logical) communication links 101 and 103.

When the game has ended, based on the outcome thereof, player-patron 106 might be awarded rewards points by gaming system 100. Player-patron 106 can use the rewards points to select a prize or chose to accumulate the rewards points over multiple games. The rewards points are typically in any electronic/digital, including cryptocurrency; they are not typically physically manifested, such as being in the form of a coin, etc. That is for processing convenience; if desired, reward points can be physically manifested, such as for novelty value (while typically keeping track of them in electronic form, as well).

Gaming system 100 also manages the rewards and prize claiming process. The gaming system transmits prize options to computing device 102 for presentation, via GUI 104, to player-patron 106. The player-patron can then select one of the offered prizes consistent with the available amount of rewards points. The prize selection is transmitted from computing device 102 to gaming system 100. The rewards/prize claim interactions, supported for example by network 116, are represented by (logical) communication links 105 and 107.

In the scenario depicted in FIG. 1A, the prizes are goods that are offered by business establishment 108. Consider an embodiment in which the business establishment is a restaurant. In such an embodiment, the prizes being offered will typically be food or beverages. Gaming system 100 transmits the player-patron's prize selection to the business restaurant's POS 110 over (logical) communications link 109. Link 109 can be used to update gaming system 100 about changes in prize availability, etc. The POS causes the establishment's kitchen to prepare the prize selection/food request. When the food is ready, representative 112—in that scenario, a food server—picks up prize 114A (the food or drink) and delivers it to player-patron 106 at the location of computing device 102. In some other embodiments, prize 114A is delivered in some manner other than by a (human) representative, such as by drone, robot, conveyor belt, vending machine, or the like.

Consider an embodiment in which business establishment 108 is a seller of merchandise. In such an embodiment, the prizes being offered will typically be merchandise offered by the merchant. Gaming system 100 transmits the prize selection of player-patron 106 to the store's POS 110, which may then direct the stockroom, for example, to retrieve the player-patron's merchandise selection. In some embodiments, once the merchandise is made available, representative 112—in that scenario, a store clerk—picks up prize 114A (the merchandise) and delivers it to player-patron 106 at the location of computing device 102.

In the scenario depicted in FIG. 1A, the prize is physically manifested; that is, it is in the form of food, drink, merchandise, etc. There are other scenarios in which the prize is not physically manifested; rather, it is in electronic form. One such scenario is depicted in FIG. 1B.

The gaming interactions and prize-claiming interactions are essentially the same for the scenarios depicted in FIG. 1A and FIG. 1B. However, rather than selecting a physically manifested prize, player-patron 106 uses rewards points won/earned to select a discount or coupon that can applied to regular purchases from the business establishment. Thus, prize 114B, in the form of an electronic/digital discount or coupon, is transmitted to computing device 102 (e.g., via e-mail to the game or personal e-mail, text, etc.).

In the scenarios depicted in FIG. 1A and FIG. 1B, the prize, whether physically manifested or in electronic form, is associated with the business establishment at which player-patron 106 is playing a game. That is, if the establishment is a restaurant, the prize could be, for example, either food offered by the restaurant or a discount that can be applied to food ordered at the restaurant. In some other scenarios, the prize is sourced from a third-party business establishment; that is, a business establishment other than the business establishment where player-patron 106 and computing device 102 are located. Such a scenario is depicted in FIG. 1C.

The gaming interactions and prize-claiming interactions are essentially the same for the scenario depicted in FIG. 1C as for the scenarios depicted in FIG. 1A and FIG. 1B. However, rather than transmitting the prize request of player-patron 106 to POS 110 of business establishment 108, the request is transmitted to POS 118 of a “third-party” business establishment 117 over (logical) communications link 111. A typical application for this scenario would be wherein the player-patron uses rewards points to obtain an electronic gift card from, for example, Amazon.com, Inc., a credit card company, etc. Thus, prize 114C, in the form of an electronic gift card, is transmitted from POS 118 to the player-patron's smart phone 119, for instance, via e-mail or SMS. As used herein and in the appended claims, the phrase “electronic form,” when referencing a prize, means a coupon, discount, gift card, etc., that is delivered electronically (e.g., to a cell phone, tablet, etc.), regardless of whether it is ultimately printed on paper, etc.

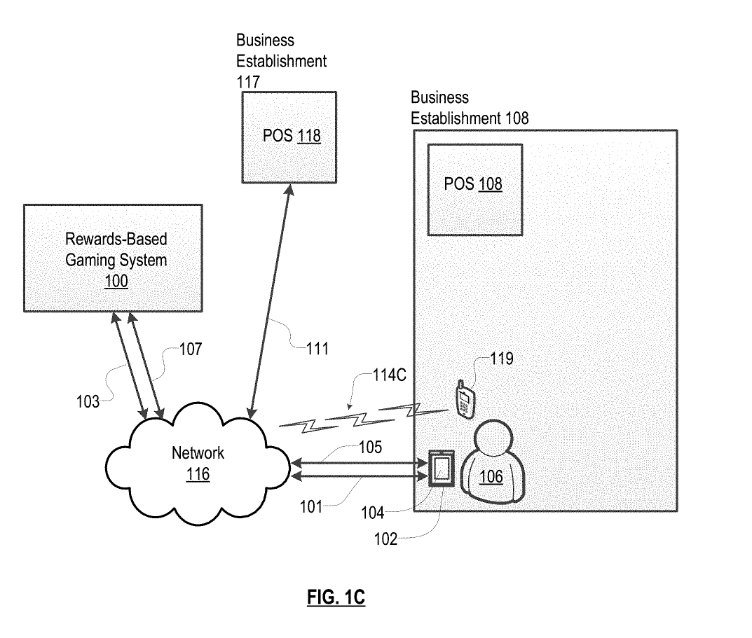

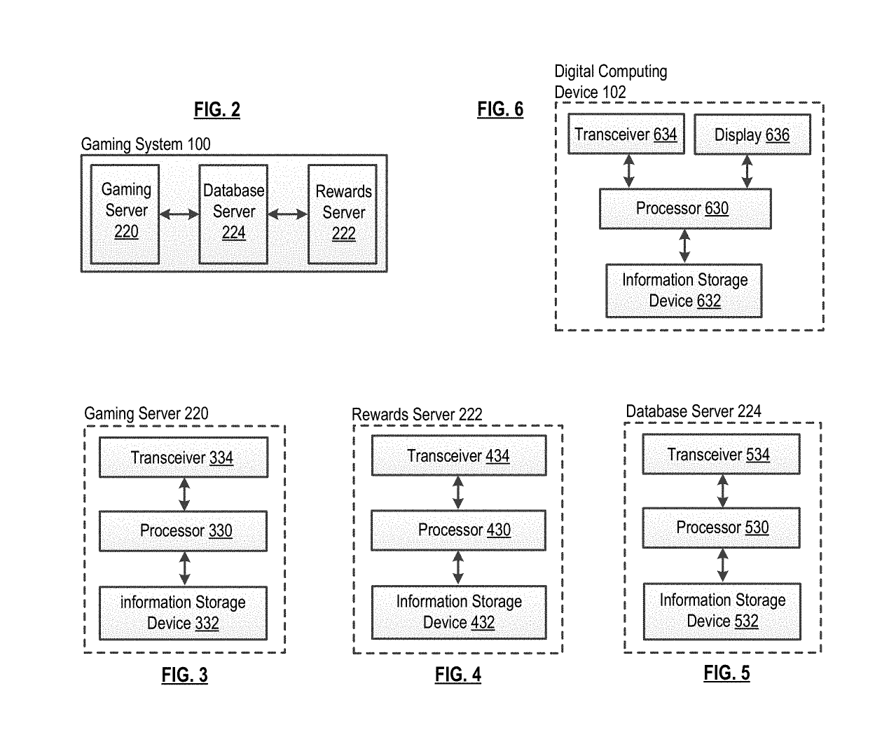

FIG. 2 depicts a block diagram of an embodiment of gaming system 100 in accordance with the present invention. As depicted, gaming system 100 includes gaming server 220, rewards server 222, and database server 224.

In the illustrative embodiment, gaming server 220 is a client-server system that runs all of the games that are made available for play. Gaming server 220 runs software that provides the game play logic and determines outcomes, in response to player-patron input, as submitted using computing device 102 (running client-side game software). The gaming server can run games from any of the four legal categories of gaming: sweepstakes, gambling, loyalty, and skill. In conjunction therewith, gaming server 220 manages three types of currencies: tokens, game credits and rewards points.

Tokens are used by a player-patron to play any game that is free to play. Typically, this would be a sweepstakes games, but in some embodiments, at least some of the loyalty or skill game offered by the system are free to play, as well. Tokens can be obtained in any one or more of the following ways: (1) earning them by performing certain actions, such as, without limitation, signing up for an account on gaming system 100, watching an advertisement, taking a survey, or ordering food or merchandise; and (2) winning them based on game outcome (rewards points can be redeemed for tokens).

Game credits are used by a player-patron to play any game that requires payment, such as gambling, and typically loyalty and skill games. Game credits can be obtained in any one or more of the following ways: (1) purchasing them by any acceptable payment method (e.g., cash, cryptocurrency, rewards miles, or third party loyalty points; (2) earning them by performing certain actions, such as, without limitation, signing up for an account on gaming system 100, watching an advertisement, taking a survey, or ordering food or merchandise; and (3) winning them based on game outcome (rewards points can be redeemed for game credits).

Rewards points are redeemed for prizes. Rewards points can be obtained in any one or more of the following ways: (1) purchasing them by any acceptable payment method (e.g., cash, cryptocurrency, rewards miles, or third party loyalty points; for cash, awards miles, or third party loyalty points) for all game types; (2) earning them by performing certain actions, such as, without limitation, signing up for an account, watching an advertisement, taking a survey, or ordering food or merchandise; (3) winning them based on game outcome, but for sweepstakes, gambling, or skill games only; and (4) earning them based on volume of play.

Rewards server 222 performs tasks related to managing the prizes that are available and managing the prize-claiming process. More particularly, rewards server 222 performs the following functions, by virtue of appropriate software, among any others:
(a) Prize Inventory and Pricing. Maintains an up-to-date list of all prizes that are available to the player-patrons and the cost of each such prize in rewards-points currency.
(b) Prize availability. Filters the list of available prizes for presentation to a player-patron based on one or more factors, including but not limited to:
   (i) player-patron location; and/or
   (ii) date or time of day; and/or
   (iii) player-patron rewards points balance; and/or
   (iv) demographic data about the player-patron.
(c) Prize claim process. Manages the prize claiming process, including:
   (i) enable the player-patron as well as customer service employees of the business establishment to view and/or update the status of outstanding prize claims;
   (ii) manage the collection of any additional information from the player-patron that might be necessary to fulfill the prize; and
   (iii) manage verification of player-patron eligibility for prizes having specific eligibility requirements.
(d) Prize drawings. This provides player-patrons that have only a small amount of rewards points a chance to win a large prize. For example, each entry into a prize drawing costs the player-patron only a small amount of rewards points. At a specified time and date, or once a specified number of entries have been made, a specified number of winners are chosen at random from all entries submitted. The winner(s) are notified by any available notification system and awarded the prize. If one or more winners do not respond within a specified time frame, replacement winners are selected.
(e) Interface with Sales system. Transmit information to venue food/merchandise sales system for handling prize fulfillment.

Database server 224 stores information required by gaming server 220 and rewards server 222 for operating the gaming system. The gaming and rewards servers are operable to query database server 224 for such information and database server is configured to be able to retrieve such information for use by the gaming and rewards servers. Furthermore, the information stored in the database server is updated on an on-going basis by gaming server 220 and rewards server 222.

FIGS. 3 through 5 depict block diagrams of the gaming server 220, rewards server 222, and database server 224. Each of these servers includes a processor (i.e., processors 330, 430, or 530), an information storage device (i.e., information storage devices 332, 432, or 532), and a transceiver (i.e., transceivers 334, 434, or 534).

Processors 330, 430, 530 are general-purpose processors that are capable of, among other tasks, executing an operating system, and executing specialized application software used in conjunction with the embodiments of the invention. Processors 330, 430, 530 are also capable of populating, updating, using, and managing data in respective information storage devices 332, 432, or 532. Furthermore, processors 330 and 430 are capable updating and accessing data stored in information storage device 532 of database server 224. In some alternative embodiments of the present invention, one or more of processors 330, 430, 530 are special-purpose processors. It will be clear to those skilled in the art how to make and use processors 330, 430, 530.

Information storage devices 332, 432, 532 are non-volatile, non-transitory memory technology (e.g., RAM, ROM, EPROM, EEPROM, hard drive(s), flash drive(s) or other solid state memory technology, CD-ROM, DVD, etc.) that store, among any other items, data and specialized application software, discussed further below in conjunction with FIGS. 7 through 9. When such software is executed, it enables processors 330, 430, and 530 to perform the features and tasks of the various embodiments of the invention. It will be clear to those skilled in the art how to make and use data-storage devices 332, 432, and 532.

Transceivers 334, 434, and 534 enable two-way communications with other devices and systems via any appropriate medium, including wireline and/or wireless, and via any appropriate protocol (e.g., Blue-tooth, WiFi, cellular, etc.). The term “transceiver” is meant to include any communications means and, as appropriate, various supporting equipment communications ports, antennas, etc. It will be clear to those skilled in the art, after reading this specification, how to make and use transceivers 334, 434, and 534.

FIG. 6 depicts a block diagram of computing device 102. The computing device includes processor 630, data storage device 632, transceiver 634, and display 636. The processor, data storage device and transceiver are adequately described by the foregoing description of processors 330, 430, and 530, information storage devices 332, 432, 532, and transceivers 334, 434, and 534, respectively. Display 636, typically LCD or LED based, presents information in visual form, in known fashion.

In the illustrative embodiment, computing device 102 is a “tablet” computer, such as, for example, an Apple iPad®, Samsung Galaxy Tab models, or the like. However, in some other embodiments, computing device 102 can take other forms, such as smart phone, lap-top computer, etc. The terms “computing device” and “tablet” are used interchangeably herein to refer to the client-side (gaming) device for use in conjunction with embodiments of the invention.

In each server 220, 222, and 224 (FIGS. 3-5) as well as tablet 102 (FIG. 6), the processor is in electrical communication with the data storage device and the transceiver. Each server and tablet includes, within its respective data storage device, one or more programs for controlling its respective processor. The processor performs the instructions of the program(s), thereby operating in accordance with embodiments of the present invention. Such programs are described in further detail later in this specification in conjunction with FIGS. 7-14.

FIGS. 7-10 depict contents of data storage devices 332, 432, 532, and 632. The contents thereof, as is germane to this disclosure, include specialized software applications as well as databases. It is to be understood that the specialized software applications, as presented in the figures, are “logical” entities in the sense that some or all of the functionality described as being associated with a particular module/application can be provided by any one or more of the other applications. Alternatively, all the functionality described for all the applications can be combined into a single specialized software application. The same is true of the databases.

FIG. 7 depicts data storage device 332 of gaming server 220. Among any other software or databases, data storage device 332 includes the following specialized application software: games module 740 and currency management module 742.

Games module 740 is software for running the games that are available for play on gaming system 100. This software provides the game logic that enables gaming server 220 to run the games that player-patrons are playing (on tablets, etc.) and to determine outcomes. Currency management module 742 manages tokens, game credit and rewards points. With respect to tokens and game credit, currency management module 742 enables processor 330 of gaming server 220 to:
check on a player-patron's token or game-credit balance to ensure that there is sufficient credit to play a game;
debit a player-patron's token or game credit balance as a consequence of play; and
provide a player-patron with options for obtaining additional tokens or game credit as required.

As to obtaining additional tokens or game credit, currency management module 742 can cause processor 330 to, for example, query the player-patron whether they are willing to watch an advertisement or take a survey for credit and, if so, cause the advertisement or survey to be served to the player-patron's tablet. As previously noted, additional game credit can be purchased by any acceptable payment method, such as, without limitation, cash, cryptocurrency, rewards miles, or third-party loyalty points. Regarding the latter two options, the system communicates with the appropriate rewards-miles or third-party loyalty points system and requests approval a payment for a particular user in the (player-patron) requested amount of rewards miles or loyalty points. The rewards-miles or loyalty system responds with an approval or rejection, which is recorded in database server 224. Approval indicates that the transaction was approved and the player will then be sold the game credits. After at some point (e.g., at one or more set times per day, etc.) the gaming system operator, or the venue operator, settles with the rewards-miles or loyalty-points system for payment in some mutually acceptable currency.

Currency management module 742 also enables processor 330 of gaming server 220 to award rewards points, as appropriate, to a player-patron and credit their rewards points account balance, and to provide a player-patron with options for obtaining more rewards points. With respect to the former, the rewards points could be awarded, for example, based on game outcome (for sweepstakes, gambling, and skill games only) or based on the player-patron's volume of game play. As to obtaining additional rewards points, currency management module 742 can cause processor 330 to, for example, query the player-patron whether they are willing to watch an advertisement or take a survey for rewards points and, if so, cause the advertisement or survey to be served to the player-patron's tablet.

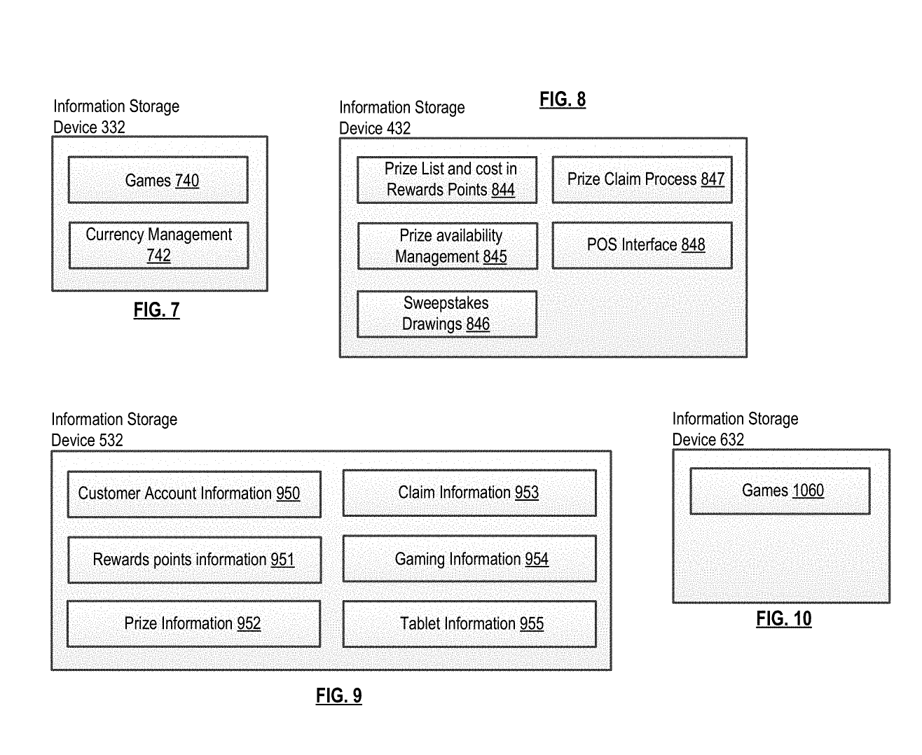

FIG. 8 depicts data storage device 432 of rewards server 222. Among any other software or databases, data storage device 432 includes the following specialized application software modules: prize list 844, prize-availability management 845, sweepstakes drawing 846, prize claim process 847, and POS interface module 848.

Prize-list module 844 is a list of prizes that are available for player-patrons to claim as prizes, along with the corresponding “cost” in rewards points. The list is, of course, unique to the particular business establishment with which gaming system is being used. Prize list module 844 is updated periodically to reflect changes in the business establishment's offerings and/or pricing. In some embodiments, updates occur electronically via communications between rewards server 222 and the POS of the business establishment. This requires that the POS is suitably configured for such communications. In some other embodiments, prize list module is updated by an email or SMS, sent from the business establishment to rewards server 222.

Prize-availability-management module 845 functions to filter the list of available prizes that are shown to any individual player-patron (i.e., transmitted, to the player-patron's tablet, for display). Filtering can be based on one or more of the following attributes:
Location of the player-patron;
Date or time of day;
The player-patron's current rewards points balance;
Any available demographic data about the player (e.g., age, prize selection history, etc.)

Sweepstakes-drawing module 846 enables processor 330 of rewards server 222 to offer certain prizes to the winner(s) of sweepstakes drawings. Entry into such a drawing costs a relatively small number of rewards points (e.g., a few hundred points, etc.). At a specified date and time, or once a specified number of entries have been received, a specified number of winners are chosen at random from all entries submitted.

Prize-claim-process module 847 enables processor 330 to manage the prize claim process, including, for example:
Enabling player-patrons and customer-service employees of the business establishment (that provides the prize) to view and/or update the status of outstanding prize claims;
Collecting any additional information from the player-patron that might be necessary to fulfill the prize request;
Verify a player-patron's eligibility for prizes they have claimed, to the extent such prizes have specific eligibility requirements.

POS-interface module 848 enables processor 330 (and hence rewards server 222) to interface with the POS of the business establishment that provides prize fulfilment, such as to transmit a prize order to the business establishment.

FIG. 9 depicts data storage device 532 of database server 224. Among any other software or databases, data storage device 532 includes the following databases: customer-account information 950, rewards-points data 951, prize data 952, prize-claim data 953, gaming data 954, and tablet information 955.

The databases in data storage device 532 of database server 224 are accessed by both gaming server 220 and rewards server 222 to update the databases and retrieve information therefrom.

Customer-account-information database 950 contains, among other information, the name, address, and other demographic information of anyone that has signed-up for an account with gaming system 100. It is notable that a player-patron does not need an account to play (i.e., they can play as a “guest”); however, without an account, any rewards points, tokens, or game credits accrued at the end of player-patron's gaming session will be lost.

Rewards-points database 951 includes rewards points balances for account holders and for guests (currently playing). Rewards-points database 951 also includes a history of rewards-points transactions for account holders and guests (currently playing). This database is regularly updated to reflect changes in account holders' balances, etc. Prize-information database 952 includes a list of prizes available for player-patrons to claim as prizes, with the corresponding “cost” in rewards points. The list is unique to the particular business establishment with which gaming system 100 is being used. Prize-information database 952 is updated periodically to reflect changes in the business establishment's offerings or pricing.

Claim-information database 953 includes historical information about the prizes that account holders have claimed. This database is regularly updated by rewards server 222. Gaming database 954 includes game-play information for each game, pay tables, and each account holders' (or guests') play history. Play history is regularly updated by gaming server 220. Tablet-information database 955 includes device information, including location, for each tablet or other device offered for game play by the business establishment.

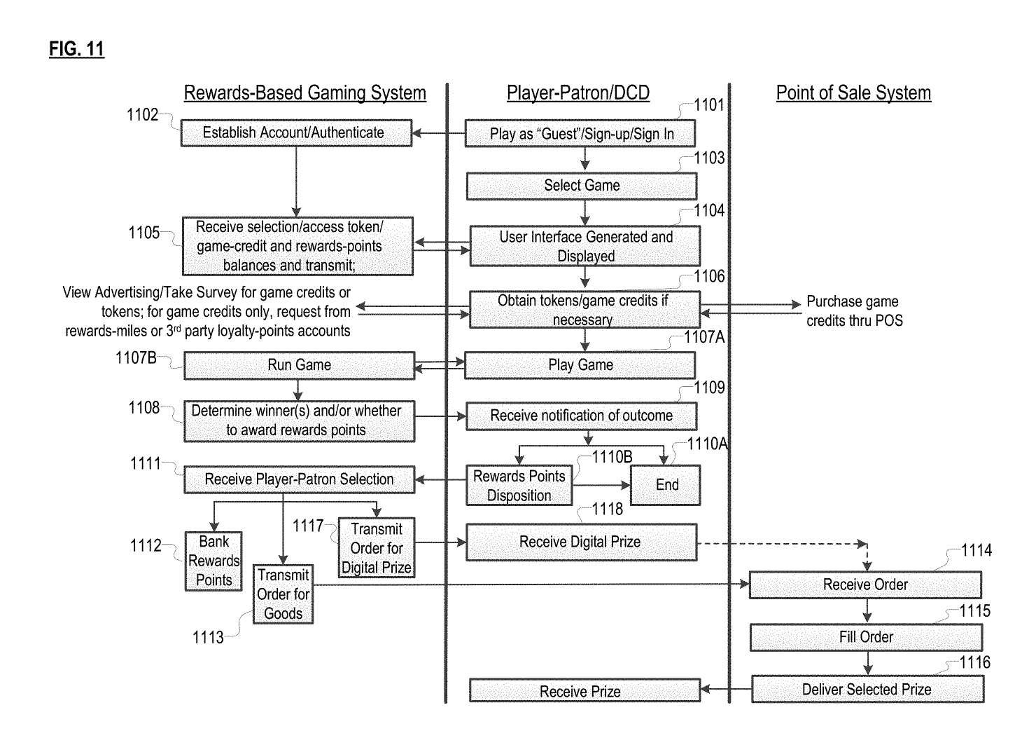

FIG. 10 depicts data storage device 632 of tablet 102. Among any other software or databases, data-storage device 632 includes the following specialized application software: gaming module 1060. The gaming module includes software that enable processor 630 of tablet 102, etc., to display a user interface for each game offered for play by gaming system 100. In the illustrative embodiment, there is a separate software application for each game. The user interface for the game enables the player-patron to interact with gaming system 100, such as by transmitting appropriate input (e.g., tokens, game credits, a wager, required player actions, etc.) to gaming server 220 to play the selected game.

FIG. 11 depicts tasks performed by gaming system 100 implementing a method in accordance with the present invention. In addition to depicting the tasks performed by the gaming system, FIG. 11 depicts tasks performed by the player-patron using a computing device/tablet and the POS of the business establishment where the player-patron is playing the game. In this embodiment, the gaming system is defined to include the gaming server, rewards server, and database server.

Although the tasks are described in a particular sequential order, they can be configured to work in a different order. That is, any particular sequence or order of tasks does not necessarily indicate a requirement that the tasks be performed in that order. The tasks of methods described herein may be performed in any order practical. Further, some tasks can be performed simultaneously.

In task 1101, the player-patron “clicks” on a soft-key, etc., on tablet 102 to access the gaming system. The player-patron is presented with the options of: “signing-in” if already an account holder, “signing-up” if an account is desired, or playing as a “guest”. In task 1102, the gaming system performs appropriate overhead tasks as function of the player-patron's status. For example, in the case of an existing account, the gaming system will authenticate the player-patron and access their account.

In task 1103, the player-patron selects a game (i.e., opens a game application) from options appearing in the display of the tablet. In the illustrative embodiment, the tablet generates a graphical user interface (“GUI”) unique to the selected game and causes it to appear on the tablet's display screen in task 1104. A GUI for use in conjunction with an illustrative embodiment of the invention is discussed further below in conjunction with FIG. 12.

Per task 1105, the gaming system receives the player-patron's game selection, accesses their tokens or game-credits balance and rewards-points balance, if any, and transmits the balances to the tablet for display in the GUI. If necessary, the player-patron is given the opportunity to obtain tokens or game credits in task 1106. As previously mentioned, tokens or game credits can be obtained, for example, by purchasing goods offered through the POS of the business establishment or by viewing advertising or taking a survey, as provided by the gaming system. Game credits, but not tokens, can be purchased by any acceptable payment method.

The game begins, per tasks 1107A or 1107B, with action by the player-patron (entering a command via the GUI) that is transmitted to the gaming system or action by the gaming system (in particular, the game server) that is transmitted to the player-patron's tablet, as a function of the game selected.

For example, a player-patron can play a single-player game, such as a “slots” game. A required amount of game credits (for a game of chance such as “slots”) are debited from the player-patron's account. The player-patron clicks a “SPIN” button that appears in the GUI. The SPIN message is transmitted to the game server in the gaming system. The gaming server determines the outcome of the spin (e.g., via a random-number generator, etc.) and sends information indicative of the outcome to the player-patron's tablet. The tablet spins the reels appearing in the GUI so that they land on the outcome determined by the game server.

In a second example, a player-patron can play a single-player versus house game, such as “blackjack”. The player-patron places a bet and clicks a “DEAL” button that appears in the GUI. The DEAL message is sent to the game server in the gaming system. The game server “draws” initial cards (from a shuffled deck) and transmits the hand (i.e., the identity of the cards that were drawn) to the player-patron's tablet. The tablet displays the cards in the GUI and queries the player-patron to “HIT” or “STAND”. The tablet transmits the response (HIT or STAND) to the game server. If the HIT message is received, the game server draws and transmits another card to the player-patron. This loop continues until the player-patron busts or STANDs. If/when the player stands, the game server plays out the dealer's hand, sending the cards drawn (if any) to the tablet as they are drawn.

In a third example, a player-patron can play a two-player competitive skill game, such as a game like “Boggle®”. A required amount of game credits are debited from the account of each player-patron unless this game is offered free of charge, in which case tokens can be used to play. The game server generates a random n×n (e.g., 4×4, etc.) game board of letters and transmits it to the table of each player-patron. The player-patrons finds as many words as they can within a given period of time (e.g., 2 minutes, etc.) and those words are transmitted to the game server. The game server determines the winner by comparing the scores of the two player-patrons. The game server then transmits winner/loser information to the tablets of the two player-patrons.

Continuing with the description of the FIG. 11, in task 1108, winner(s)/loser(s) are determined and/or a decision of whether to award rewards points is made and transmitted to the player-patron's tablet. The player-patron receives notification as to outcome and/or whether rewards points have been awarded in task 1109.

If points have not been awarded and if the player-patron has insufficient rewards points to select a prize, then, per task 1110A, processing ends (e.g., the player-patron can choose to play another game or quit playing).

If the player-patron has been awarded rewards point and/or has sufficient rewards points saved to select a prize, a disposition for the rewards points is determined at task 1110B. If the player-patron has been awarded points, but the amount is insufficient for any prize, the rewards points are automatically banked (i.e., accumulated in the player-patron's account) at task 1112 and processing ends (e.g., the player-patron can choose to play another game or quit playing).

If the player-patron has been awarded rewards points and that amount of points is sufficient to acquire a prize, at least some prize options will be displayed in the GUI appearing in the display of player-patron's tablet. As noted earlier, in some embodiments, the prize options being displayed have been filtered by the rewards server of the gaming system, based on various attributes (e.g., location of the player-patron, date/time of day, rewards points balance, demographic data about the player-patron, etc.). In some embodiments, prize options are displayed in the GUI regardless of whether the player-patron has a sufficient point balance to choose such prizes (e.g., see, FIG. 12: image of “lock” appearing in prize window to indicate that insufficient rewards points are available).

If the amount of awarded points is insufficient for a prize of interest, the player-patron will request that the rewards points be banked. The request is received at task 1111 and the points are banked per task 1112. If the player-patron has not been awarded points, but has a sufficient amount of rewards points for a prize, they can submit a request for a prize or choose to play another game, or quit playing.

If the player-patron decides to select a prize (based on newly awarded points, a combination of newly awarded points and accumulated points, or only accumulated points) based from prize options displayed in the GUI, the request is received by the rewards server of the gaming system at task 111.

Subsequent processing depends on the nature of the selected prize. For example, if the player-patron selects goods, as appropriate for the business establishment in which the game was played (e.g., restaurant, casino, hotel: food or drink, merchandise establishment: merchandise, etc.), the rewards server of the gaming system transmits, in task 1113, an order for such goods to the POS of the business establishment. Per task 1114, the POS receives the order and, in task 1115, fills the order within minutes (as a function of food-preparation time, etc.). A service representative of the business establishment then delivers the prize, generally within 30 minutes of the time it was ordered, to the player-patron at the (known) location of the tablet in accordance with task 1116.

Alternatively, if the player-patron has selected a prize that can be electronically delivered, the rewards server transmits an order for the prize, per task 1117, to either the POS of the business establishment at which the player-patron is located or a third-party business establishment. With respect to the former, illustrative prizes include a coupon, discount, or a gift card, all redeemable for goods that can be purchased from the business establishment. As to the latter, an illustrative prize includes a gift card from a credit card company, Amazon®, etc.

In task 1118, the electronic prize is received at the tablet or smart phone of the player-patron. If the prize is a coupon or discount that the player-patron applies soon thereafter to a purchase from the business establishment, an order is transmitted to the POS of the business establishment, which is received, filled, and delivered to the player-patron.

FIG. 12 depicts an illustrative GUI for a slots game that can be played in conjunction with embodiments of the gaming system. As previously described, in the illustrative embodiment, the GUI is generated by specialized software that resides on the computing device/tablet.

The GUI includes “credit” icon 1260 and balance window 1262. The player-patron's game credit balance (i.e., “900” credits in the example) is displayed in balance window 1262. Selecting “GET MORE” soft key 1264 provides the player-patron with options, as previously discussed, for obtaining more game credits. Next to the game-credit balance window is “rewards points” icon 1266 and balance window 1268. The player-patron's rewards points balance (i.e., “0” points in the example) is displayed in balance window 1268. Selecting the “GET REWARDS” soft key 1270 provides the player-patron with options, as previously discussed, for obtaining additional rewards points.

The GUI includes a plurality of reels 1274 (five in the illustrative embodiment), each reel bearing a number of symbols 1276. The player-patron bets a number of game credits in betting window 1280, using the “+” soft key 1282 or “−” soft key 1284 to increment or decrement the bet. The player-patron presses the “SPIN” soft key 1286, which, as discussed earlier, transmits a “spin” command to the game server. The game server determines the outcome of the spin and transmits it back to the tablet, which then spins reels 1274 such they ultimately display the outcome determined by the game server. “GAME OVER” indicator 1289 illuminates to indicate that the game is over.

The outcome of every “spin” of the reels is stored by the gaming system (in a database accessible to the database server). Each spin is assigned an identification number 1288. In the example, that number is “ID 1487”. The player-patron can press “HELP” soft key 1278 for playing instructions.

“JACKPOT” window 1290 provides the current amount of the jackpot in rewards currency (in the example, 250,000 points). Pressing “additional games” soft key 1291 accesses a list of games available for play.

Prize windows 1292 (four are shown) provide the player-patron with prize options. Each window 1292 includes image 1293 (providing an illustration of the prize), cost-to-purchase 1294 (in rewards points), lock icon 1295 (indicating insufficient rewards points balance), and description 1296 (of the prize). Pressing MORE soft key 1297 (associated with the right-most prize window) causes different prize options to be displayed in the first three prize windows 1292.

There are several soft keys at the bottom of the GUI. These soft keys display icons for “flight,” “home,” “food,” “drinks,” and “internet.” When pressed, these soft keys clear the game screen and provide, respectively, flight information, the home page, food menu, drink menu, or access the internet.

Further embodiments described herein provide more details for offering customers/users/patrons an opportunity to remotely order food and drink/beverage, while playing a game at a venue on a device (e.g., electronic device) that is fixed at a location or on a handheld device, and then have the order delivered to the customer's identifiable location within the venue, or indicated by the user otherwise. More broadly speaking, the invention is applicable to a remote ordering system accessible within an electronic application during a reward-based gaming session for the purchase and delivery of the food and/or beverage to an identifiable location.

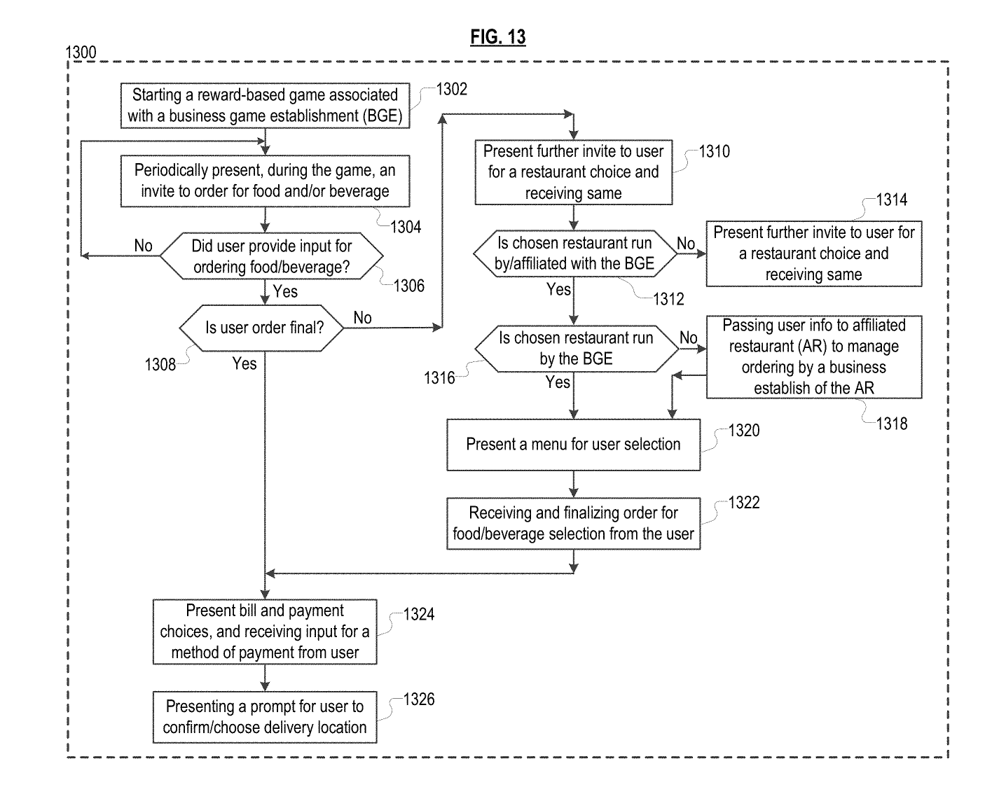

Embodiments of the invention may involve electronic communications and processing, so food and beverage and other retail establishments within a venue can conduct transactions remotely and deliver purchases to identifiable locations. In particular, the transaction can be conducted through the establishment's order-fulfillment system, which can be accessible within or in conjunction with an application being played by the customer/user/patron (see examples in FIGS. 13-15). The order-fulfillment system may handle both ordering and/or payment and may be suitably enabled to support additional functionalities disclosed herein.

According to one embodiment, customers using an electronic device (such as smartphone, i-Phone®, i-Pad® or other tablet, computer, etc.) may be able to access the establishment's order-fulfillment system through a user interface (e.g., menu bar) integrated within the application, enabling a customer to order and pay for food or beverage (or other retail goods or services) without leaving his/her seat during the game. Once the customer's initial order and e-payment are processed, he/she can be able to quickly re-order items (e.g., another beverage) without having to re-enter payment and delivery details. The additional functionality discussed below (such as the methods by which food and beverage are paid for, and the methods for identifying a customer's location) can reside on the electronic device, or the electronic device can be in communication with a server of a business game establishment (BGE), which can execute software that provides the additional functionality.

Although food and beverage and other retail goods and services in airports, hotels, stadiums, arena's etc. are preferred establishments for using embodiments of the invention, it is to be understood that embodiments of the invention can be used for purchasing of the food and beverage and the like in other business environments as well.

Once a customer completes an order in the system, a payment is required. The payment can be accepted as reward points from the game, cash on delivery, e-payment (e.g., using a credit card, debit card, electronic fund transfer (EFT), etc.), airline miles, by winning items directly or the like.

In one exemplary embodiment, a possible application of the food and beverage service can be during a game of skill (such as chess, crossword puzzle, etc.), a game of chance (such as gambling, sweepstakes, fantasy, etc.), or a hybrid, wherein a player can earn rewards points for successful achievements, consistent or prolonged game play, and the like. In other embodiments, the application can be based on entertainment, utilities, news, productivity, lifestyle, social networking and the like. In these embodiments, rewards points can be earned for various accomplishments (e.g., having a high number of contacts or friends), challenges (e.g., getting 100 “likes” to a shared post), marketing or advertising inquiries (e.g., completing a survey), etc. Rewards points can then be redeemed for food or beverage (or other retail goods) and services can be offered through the order-fulfillment system of the business game establishment (BGE).

In other embodiments, the system can present customers through applications, either at random or methodically, opportunities to earn rewards points. These opportunities can be used for a variety of purposes including encouraging customers to purchase food or beverages (e.g., by providing rewards points, extra discounts, or appetizing photos), advertising brands, or other business promotions (e.g., purchase an entrée and get a free beverage).

In other embodiments, the system may allow customers/users to win prizes directly. Prizes may include, but are not limited to, food and beverages. For example, a customer that receives a certain combination on a slot machine can win a free soft drink of their choice.

Before or after the customer's e-payment is entered (e.g., swiped, etc.) into the order-fulfillment system to pay for the food and/or beverage, but before the payment is processed, the customer may be given the opportunity to apply rewards points earned within the application as a discount to the cost of the order. If the customer wishes to forego this opportunity and simply pay for his/her order, he/she can reply appropriately and the transaction can be processed at the prevailing price. If, however, the patron wishes to apply rewards points to his/her order, he/she can reply appropriately and the discount will be applied to the total cost of the order.

In other embodiments, the order can be paid for in a variety of different ways. For example, some items can only be paid for in cash, while others can be paid for using only rewards points, and yet others can be paid for using a combination of both currencies. Also, it could be no limitation within the system to the number of reward currencies accepted. For example, there can be “regular rewards points” and also “premium rewards points”, such that certain food and beverage items can only be purchased using premium points (or at least some premium points).

After the customer's e-payment is entered into the order-fulfillment system, and the payment is processed, the business game establishment (BGE) should be provided with the order and delivery location. To assure accurate delivery of the order, it is necessary to identify the location of the customer within the venue. In BGEs where the electronic device is fixed to a particular seat location (such as iPad® kiosk in the airport, gaming machine in a casino), the delivery location can be automatically associated with the location of the fixed gaming device/electronic device. All fixed devices within a venue can be associated with an identification code specifying the seat location. Then the identification code will be automatically associated with the customer's order when purchasing items using the fixed electronic device, so that the establishment is able to accurately identify the delivery location. Usually venues, which provide the order-fulfillment system, clearly mark all seats with an identifiable code, so that orders can be accurately delivered to customers based on the location identification codes. However, when personal wireless devices, which are not associated with an identification code, are used to place orders, the customer may be asked to manually input their seat location (or an identifiable desired location) for delivery purposes.

In other embodiments, identifying a customer's location can be possible using an automatic location system (such as GPS and the like), which can identify a customer's electronic device over a wireless network within a predetermined geographic area. In this embodiment, once the wireless network determines the location of a customer's electronic device, the order-fulfillment system can associate it with the customer's order. After the customer's e-payment is processed, the location of the customer's device can be identified as the delivery location. If the customer wishes to receive the order at the identified location, he/she can reply appropriately and the order can be processed for delivery to that identified location.

In other embodiments, the delivery location may not be the location of the electronic device identified by the location system. If the customer wishes to receive the order at a different location, then the desired identifiable delivery location can be entered manually.

Furthermore, in order to provide an adequate service to customers/users/patron, the invention presents a new method and apparatus for providing periodic offering of food/beverage services to the users during the reward-based game.

According to an exemplary embodiment of the invention, a method for operating a computing/electronic device utilizing at least one corresponding application for implementation of ordering food and beverage by a user involved in a game administered by a business game establishment (BGE) of a reward-based gaming system, is described as follows. The computing device can display/present during the game, at periodic time intervals, an invite for the user to place an order for a food, a beverage or both the food and beverage.

As non-limiting examples, the periodic time intervals may be 15 minutes, 20 minutes, 30 minutes, etc. and can be pre-set/set/adjusted in the system (e.g., using an adjustable timer, see FIG. 15). Also a duration of the displayed/presented invites (i.e., a time duration for the user to make a decision/choice), or presentation exposure, can be set, as non-limiting examples, to 30 seconds, 45 seconds 60 seconds, 90 seconds, etc. and can be pre-set/set/adjusted in the system (e.g., using an adjustable timer, see FIG. 15). Presenting the invites only at periodic short time durations would minimize distracting the user from the game, allowing him/her to make a quick choice/decision and to get back to the game. Also the invite may further include an option to postpone answering the invite or to request re-sending the invite at a time after finishing a current game.

Moreover, the aforementioned invite (as well further operations related to ordering food/beverage using the computing device as described herein) can be displayed/presented on one or more screens/touch screens, electronic displays, graphical users interfaces (GUIs), which may include a combination (at least one or more) of graphical icons, visual indicators, typed command labels, displayed text and pictures, as well as having text-based user input capabilities. The invite may also be displayed/located at a designated area of a screen/display (e.g., used for playing the game) or on a dedicated display/screed/GUI, according to various embodiments of the invention.

Moreover, the invite may also comprise one or more of: the available user reward points from the game, promotions, gift cards, coupons and airline mile points, based on the user identity established for the BGE at a start of or during the game through the computing device. It is further noted that periodic invites for food and/or beverage can be independent from other invites/promotions possibly having a broader scope (such as offers to buy various non-food items, make flight reservations, reserve trips, rent a car and the like) within the game venue presented, for example, after ending the game session and/or when a user has won a big prize. Also, in some applications, the user can initiate at any time a food/beverage order by pressing a corresponding button “Food” or “Drinks” (if available) like shown in FIG. 12.

Furthermore, according to various embodiments, the at least one corresponding application, referred to above, can be an application dedicated only to ordering and providing the food and beverage to the user. Alternatively, it can be a part of a game application, or can be divided on a number of sub-applications and loaded at different devices/servers within a communication network (see FIG. 15). Thus, the at least one corresponding application can be located: a) on the computing device, b) on a BGE server or c) on both the computing device and the BGE server, where the at least one corresponding application comprising more than one application. It can also be located (at least in part) on points of sale associated with the BGE and e.g., communicating with the BGE server and the computing device through a wireless network (see FIG. 15).

Thus, summarizing, according to various embodiments of the invention, the computing/electronic device described herein (without considering additional applications at the points of sale associated with the BGE) can be one of:
a) a computer/electronic game device used for gaming and comprising the at least one corresponding application or communicating with the at least one corresponding application at the BGE server;
b) a computing/electronic device comprising the at least one corresponding application or communicating with the at least one corresponding application at the BGE server, wherein the communicating device being complimentary to a game device both belonging to the BGE; and
c) an independent user personal wireless device (e.g., smart phone) having the at least one corresponding application loaded before the game started or communicating with the at least one corresponding application at the BGE server.

Moreover, according to a further embodiment, the invite may also comprise one or more of: menu choices for food, menu choices for beverage, and a choice for restaurants.

According to a further embodiment, in response to the invite, the user can ignore/refuse the invite (or postpone making a decision as described above). Alternatively, the user can provide to the computing device a user input for ordering the food, the beverage or both the food and beverage. The user input may comprise one of: a) the final order for ordering the food, the beverage or both the food and beverage, b) a partial order of the food, the beverage or both the food and beverage, and a request for a further selection of available restaurants and corresponding menu choices, and c) only an intent for ordering the food, the beverage or both the food and beverage including a request for a selection of available restaurants and corresponding menu choices.

In response to the received user input, the computing device can implement: a) a selection by the user, if requested in the user input, a restaurant and menu choices for generating a final order, b) a further payment for the final order by presenting payment alternatives to the user including at least user reward points from the game based on a user identity, and c) a further clarification of a location for delivery of the order to the user; wherein the computing device being in communication with a BGE server. The user identity can be established for the BGE at a start of or during the game using the computing device, so that the BGE can apply relevant user reward points, prizes and the like as described herein.

For the purpose of this invention, a term “restaurant” should be interpreted as any restaurant or eating/drinking place, a cafe and the like, which are arranged to prepare and deliver food/beverage through electronically placed orders.

Then according to another embodiment of the invention, a further implementation may comprise: displaying/presenting to the user (by the computing device) a further invite for choosing a restaurant, the further invite can include one of: a) one or more restaurants run by the BGE, b) one or more restaurants run by and affiliated with the BGE and c) one or more restaurants run by and affiliated with the BGE, and a user choice of an independent restaurant. Then the computing device can receive a restaurant choice entered by the user.

If the user choice comprises an independent restaurant, the computing device can provide to the user a way of communicating (contact information) with the independent restaurant directly using a personal wireless device of the user (if this information available at the BGE). However, if the chosen restaurant is the restaurant run by or affiliated with the BGE, the implementing may further comprise: displaying/presenting to the user a corresponding menu for the restaurant chosen by the user; and receiving an order comprising selected menu items from the corresponding menu by the user and generating a bill for the final order including a partial order if placed by the user in the user input for ordering the food/beverage in response to the invite.

According to a further embodiment, the order implementing can further comprise displaying/presenting the bill for the final order and a payment invite comprising payments choices, where payment categories can include one or more of: a) the available user reward points from the game, game prizes, promotions, gift cards, coupons, airline mile points and the like, based on the user identity established for the BGE at a start of or during the game through the computing device, b) a credit card payment, a debit card payment or an electronic fund transfer (EFT), and c) cash on delivery, so that the user can make an appropriate selection of one or more of the payment categories to pay for the order.

According to a further embodiment, after the method of payment is entered by the user, the computer device can display/present a prompt for the user to confirm/choose a delivery location, so that the user can choose a location of the computing device, which can be known by a point of sale (POS) run by or affiliated with the business game establishment (BGE), or can specify a different location, for delivery of the order.

FIGS. 13-15 illustrate various embodiments for providing periodic offering of food/beverage services to the user by the reward-based gaming system.

FIG. 13 is depicts a flowchart of method 1300, which implements embodiments disclosed herein in reference to providing food/beverage services to the users during the rewards-based game. It is noted that the order of steps shown in FIG. 13 is not required, so in principle, the various steps may be performed out of the illustrated order. Also certain steps may be skipped, different steps may be added or substituted, or selected steps or groups of steps may be performed in a separate application, following the embodiments described herein.

In task 1302 of method 1300, a reward-based game (associated with a business game establishment (BGE)) is started and, in task 1304, a computing device displays/presents periodically during the game an invite for the user to place an order for food and/or beverage (optionally showing reward points, promotions, restaurant choices and/or menu choices etc., as described herein).

In task 1306, it is determined whether a user input is provided for ordering food and/or beverage. If this is not the case, the process loops back to task 1304. If, however, the user provides an input to the computing device for ordering the food and/or beverage, in task 1308, it is determined whether the user input comprises a final order from a menu choice (if being presented in the invite) without any further requests. If that is the case, the method proceeds to task 1324 as described below. If, however, the user order is not finalized, e.g., the user expresses intent to order from a restaurant/menu not comprised in the invite, or that this intent is in addition to a partial order placed based on the menu choice comprised in the invite, then in task 1310, the computing device displays/presents a further invite for the user for a choice of a restaurant (if the user input expresses the intent to order from another restaurant) and further receives a restaurant choice from the user.

In task 1312, it is determined whether the chosen restaurant is run or affiliated with the BGE. If that is not the case, then in task 1314, the computing device provides contact information to the user about the chosen restaurant. This task can be optional depending on whether the BGE has contact information. If, however, the chosen restaurant is run by or affiliated with the BGE, then in task 1316 it is further determined whether the chosen restaurant is run by the BGE. If that is not the case (i.e., the chosen restaurant is only affiliated with the BGE), then in task 1318, the user information can be passed to this affiliated restaurant (AR) by the BGE server (see FIG. 15 for illustration) to manage ordering the food/beverage by a business establishment of the AR (or in conjunction with the BGE server); then the method proceed with task 1320.

If, however, the chosen restaurant is run by the BGE as determined in task 1316, then in task 1320, the computing device presents/displays a menu associated with the chosen restaurant for user selection. In task 1322, the computing device receives and finalizes the order for food/beverage from the user (after making a choice by the user in response to task 1320).

In task 1324, the computing device displays/presents a bill for the final order and payment choices including game reward points, other promotions and payment options as described herein, and receiving input for a method of payment by the user. Finally, in task 1326, the computing device displays/presents a prompt for the user to confirm/choose a delivery location (such as a known location of the computing device, or another location specified by the user). Based on the confirmed/chosen location, the order is delivered to the user.

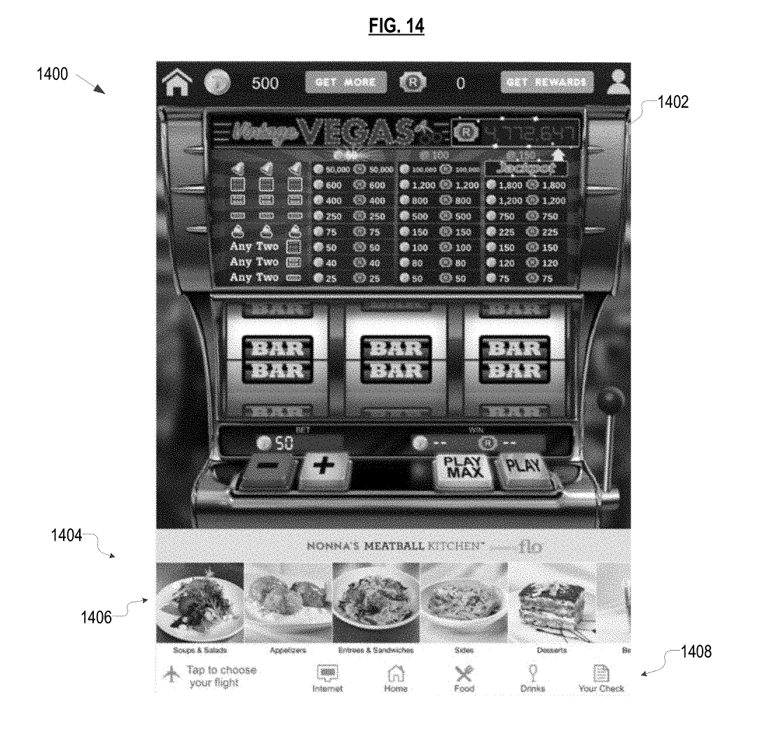

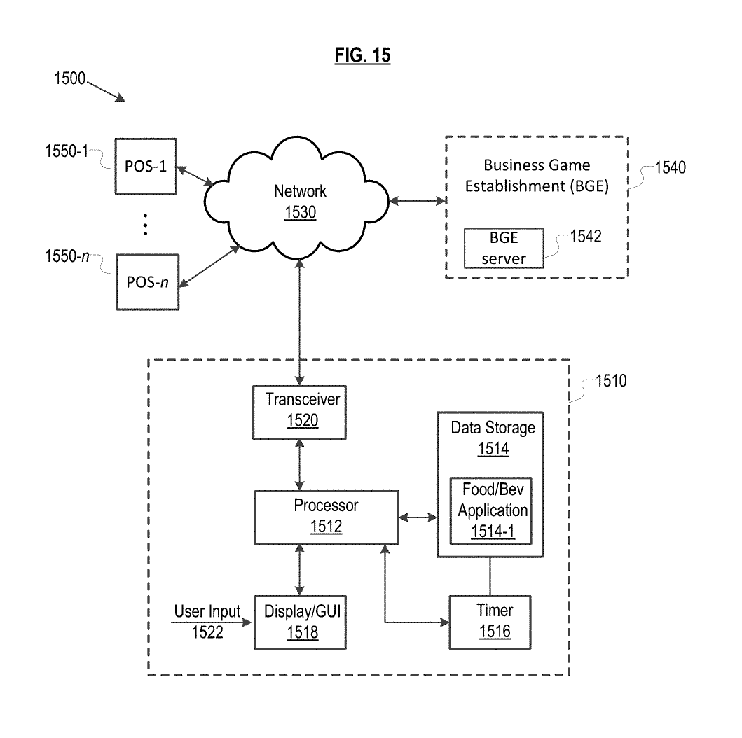

FIG. 14 shows an exemplary illustration of a reward-based game system 1400 configured to provide food/beverage services to the user during the game, according to various embodiments described herein. The game device 1402 is located next to (and/or in conjunction with) a computing device 1404 having its display/GIU displaying/presenting menu food items 1406 which can be periodically displayed as described herein. Additional panel 1408 also show different icons for independent choices which can be made by the user during the game.

FIG. 15 shows an example of a simplified block diagram of a computing device 1510 (within a communication system 1500), which is in communication with business game establishment (BGE) 1540 through a communication network 1530 (e.g., a wireless local area network) according to an exemplary embodiment of the invention for providing food/beverage services to a user during a game.

Computing device 1510 comprises at least one processor 1512, data storage 1514 (e.g., for storing game-related applications and an application 1514-1 for implementing food/beverage services as described herein (e.g., as shown in FIG. 13), an adjustable timer 1516, a display/GUI 1518 (which may include one or more screens/touch screens, electronic displays, at least one GUI and the like) for displaying pertinent information and facilitating user input 1522, and a transceiver 1520 configured for communicating with BGE server 1542 of business game establishment (BGE) 1540 and corresponding point of sale terminals POS-1 1550-1, . . . POS-n 1550-n, n being a finite integer of one or more, to facilitate corresponding tasks 1318-1326 described in conjunction with FIG. 13. It is noted that the point of sale terminals POS-1 1550-1, . . . POS-n 1550-n may represent restaurants affiliated with the BGE 1540 (as described herein), whereas point(s) of sale directly run by the BGE 1540 are not shown in FIG. 15 but it is assumed that for practical purposes the BGE server 1542 is in possession of all required information to facilitate tasks 1320-1325 of FIG. 13.

Various embodiments of data storage 1514 may include any technology type suitable to the local technical environment, including but not limited to semiconductor-based memory devices, magnetic memory devices and systems, optical memory devices and systems, fixed memory, removable memory, disc memory, flash memory, DRAM, SRAM, EEPROM and the like. Various embodiments of the processor 1512 include, but are not limited to, general-purpose computers, special-purpose computers, microprocessors, digital signal processors (DSPs) and multi-core processors.

Adjustable timer 1516 may be implemented as an application computer program stored, e.g., in data storage 1514, but in general it may be implemented as software, firmware and/or a hardware module or a combination thereof. In particular, in the case of software or firmware, one embodiment may be implemented using a software related product such as a computer readable memory (e.g., a non-transitory computer readable memory), computer readable medium or a computer readable storage structure comprising computer readable instructions (e.g., program instructions) using a computer program code (i.e., the software or firmware) thereon to be executed by a computer processor.

Furthermore, the modules 1516, 1518 and 1514-1 may be implemented as a separate block or may be combined with any other module/block of the apparatus 1500 or it may be split into several blocks according to their functionality. For example, the application 1514-1 can be a part of a played game application or can be a separate application. Moreover, it is noted that all or selected modules of the computing device 1510 may be implemented using an integrated circuit (e.g., using an application specific integrated circuit, ASIC).

The term “non-transitory” is to be understood to remove only propagating transitory signals per se from claim scope and does not relinquish rights to all standard computer-readable media that are not only propagating transitory signals per se.

Unless defined otherwise, technical and scientific terms used herein have the same meaning as is commonly understood by one having ordinary skill in the art to which this disclosure belongs. The terms “first”, “second”, and the like, as used herein, do not denote any order, quantity, or importance, but rather are employed to distinguish one element from another. Also, the terms “a” and “an” do not denote a limitation of quantity, but rather denote the presence of at least one of the referenced items. The use of “including,” “comprising” or “having” and variations thereof herein are meant to encompass the items listed thereafter and equivalents thereof, as well as additional items. The terms “connected” and “coupled” are not restricted to physical or mechanical connections or couplings, and can include electrical and optical connections or couplings, whether direct or indirect.

Furthermore, the skilled artisan will recognize the interchangeability of various features from different embodiments. The various features described, as well as other known equivalents for each feature, can be mixed and matched by one of ordinary skill in this art, to construct additional systems and techniques in accordance with principles of this disclosure.

In describing alternate embodiments of the apparatus claimed, specific terminology is employed for the sake of clarity. The invention, however, is not intended to be limited to the specific terminology so selected. Thus, it is to be understood that each specific element includes all technical equivalents that operate in a similar manner to accomplish similar functions.

It is noted that various non-limiting embodiments described and claimed herein may be used separately, combined or selectively combined for specific applications. Further, some of the various features of the above non-limiting embodiments may be used to advantage, without the corresponding use of other described features. The foregoing description should therefore be considered as merely illustrative of the principles, teachings and exemplary embodiments of this invention, and not in limitation thereof. It is to be understood that the disclosure describes a few embodiments and that many variations of the invention can easily be devised by those skilled in the art after reading this disclosure and that the scope of the present invention is to be determined by the following claims.

What is claimed is:

1. A method for operating a computing device utilizing at least one corresponding application for implementation of ordering food and beverage by a user involved in a game administered by a business game establishment (BGE) of a reward-based gaming system, the method performed by the computing device comprising:
displaying/presenting during the game, at periodic time intervals, an invite for the user to place an order for a food, a beverage or both the food and beverage;
receiving a user input for ordering the food, the beverage or both the food and beverage; and
implementing a further selection by the user, if requested in the user input, a restaurant and menu choices for generating a final order, a further payment for the final order by presenting payment alternatives to the user including at least user reward points from the game based on a user identity, and a further clarification of a location for delivery of the order to the user,
wherein the computing device being in communication with a BGE server.

2. The method of claim 1, where the invite also comprises one or more of: the available user reward points from the game, promotions, gift cards, coupons and airline mile points, based on the user identity established for the BGE at a start of or during the game through the computing device.

3. The method of claim 1, where the invite also comprises one or more of: menu choices for food, menu choices for beverage, a choice of restaurants.

4. The method of claim 1, wherein the user input comprises one of: a) the final order for ordering the food, the beverage or both the food and beverage, b) a partial order of the food, the beverage or both the food and beverage, and a request for a further selection of available restaurants and corresponding menu choices, and c) only an intent for ordering the food, the beverage or both the food and beverage including a request for a selection of available restaurants and corresponding menu choices.

5. The method of claim 1, wherein the user identity is established for the BGE at a start of or during the game using the computing device.

6. The method of claim 1, wherein the at least one corresponding application is located: a) on the computing device, b) on the BGE server or c) on both the computing device and the BGE server, where the at least one corresponding application comprising more than one application.

7. The method of claim 1, where the at least one corresponding application is an application dedicated only to ordering and providing the food and beverage to the user.

8. The method of claim 1, wherein the computing device is one of:
a) a computer/electronic game device used for gaming and comprising the at least one corresponding application or communicating with the at least one corresponding application at a BGE server,
b) a computing/electronic device comprising the at least one corresponding application or communicating with the at least one corresponding application at the BGE server, wherein the communicating device being complimentary to a game device both belonging to the BGE, and
c) an independent user personal electronic wireless device having the at least one corresponding application loaded before the game started or communicating with the at least one corresponding application at the BGE server.

9. The method of claim 1, wherein the periodic time intervals are 15 minutes with a presentation exposure of 45 seconds.

10. The method of claim 1, where the invite further includes an option to postpone answering the invite or to request re-sending the invite at a time after finishing a current game.

11. The method of claim 1, wherein the implementing comprises:
displaying/presenting to the user a further invite for choosing a restaurant, the further invite comprises one of:
a) one or more restaurants run by the BGE,
b) one or more restaurants run by and affiliated with the BGE,
c) one or more restaurants run by and affiliated with the BGE, and a user choice of an independent restaurant; and
receiving a restaurant choice entered by the user.

12. The method of claim 11, wherein, if the chosen restaurant is the restaurant run by or affiliated with the BGE, the implementing further comprises:
displaying/presenting to the user a corresponding menu for the restaurant chosen by the user; and
receiving an order comprising selected menu items from the corresponding menu by the user and generating a bill for the final order including a partial order if placed by the user in the user input for ordering the food/beverage in response to the invite.

13. The method of claim 12, wherein the implementing further comprises:
displaying/presenting the bill for the final order and a payment invite comprising payments choices, where payment categories include one or more of:
a) the available user reward points from the game, promotions, gift cards, coupons and airline mile points, based on the user identity established for the BGE at a start of or during the game through the computing device,
b) a credit card payment, a debit card payment and an electronic fund transfer (EFT),
c) cash on delivery,
so that the user makes an appropriate selection of one or more of the payment categories to pay for the final order.

14. The method of claim 13, wherein, after a method of payment is entered by the user, the method further comprises:
displaying/presenting a prompt for the user to confirm/choose a delivery location, so that the user chooses a location of the computing device, known by a point of sale (POS) run by or affiliated with the business game establishment (BGE), or specify a different location, for delivery of the final order.

15. The method of claim 11, if the user choice comprises an independent restaurant, the method further comprises:
providing to the user a way of communicating with the independent restaurant directly using a personal wireless device of the user.

16. A computing device, utilizing at least one corresponding application for implementation of ordering food and beverage by a user involved in a game administered by a business game establishment (BGE) of a reward-based gaming system, the computer device comprising:
a processor; and
a memory for storing program logic, the program logic executed by the processor, the program logic comprising:
logic for displaying/presenting during the game, at periodic time intervals, an invite for the user to place an order for a food, a beverage or both the food and beverage;
logic for receiving a user input for ordering the food, the beverage or both the food and beverage; and
logic for implementing a further selection by the user, if requested in the user input, a restaurant and menu choices for finalizing an order, a further payment for the final order by presenting payment alternatives to the user including at least user reward points from the game based on a user identity, and a further clarification of a location for delivery of the order to the user,
wherein the computing device being in communication with a BGE server.

17. The computing device of claim 16, where the invite also comprises one or more: menu choices for food, choices for beverage, and a choice of restaurants.

18. A non-transitory computer readable storage medium tangibly storing computer program instructions capable of being executed by a computer processor, the computer program instructions defining code for:
displaying/presenting during a game, at periodic time intervals, an invite for the user to place an order for a food, a beverage or both the food and beverage for facilitating ordering food and beverage by a user involved in the game administered by a business game establishment (BGE) of a reward-based gaming system;
receiving a user input for ordering the food, the beverage or both the food and beverage; and
implementing a further selection by the user, if requested in the user input, a restaurant and menu choices for finalizing an order, a further payment for the final order by presenting payment alternatives to the user including at least user reward points from the game based on a user identity, and a further clarification of a location for delivery of the order to the user,
wherein the computing device being in communication with a BGE server.

19. The non-transitory computer readable storage medium of claim 18, where the invite also comprises one or more of: the available user reward points from the game, promotions, gift cards, coupons and airline mile points, based on the user identity established for the BGE at a start of or during the game through the computing device.

20. The method of claim 18, wherein the periodic time intervals are 30 minutes with a presentation exposure of 60 seconds.
